(19) United States
(12) Patent Application Publication
(10) Pub. No.: US 2024/0305043 A1
(43) Pub. Date: Sep. 12, 2024

(54) Lever-Type Connector

(71) Applicant: TE Connectivity Italia Distribution S.R.L., Torino (IT)

(72) Inventors: Marco BARBERIS, Torino (IT); Carla CASTAGNO, Torino (IT); Alessio GALANO, Torino (IT); Mohammad M. NAZZAL, Torino (IT)

(73) Assignee: TE Connectivity Italia Distribution S.R.L., Torino (IT)

(21) Appl. No.: 18/595,484

(22) Filed: Mar. 5, 2024

(30) Foreign Application Priority Data
Mar. 8, 2023 (IT) 102023000004347

(51) Int. Cl. H01R 13/629; H01R 43/26

(52) U.S. Cl. CPC H01R 13/62933; H01R 43/26

(57) ABSTRACT

The present invention refers to a lever-type connector comprising a connector and a lever pivotally mounted on the connector and configured to secure a connection between the connector and a mating connector, wherein the lever-type connector further comprises a gripping component configured to be gripped by an operator. The gripping component is pivotally mounted on an external part of the lever facing the operator, in such a way that a movement of the gripping component automatically induces a movement of the lever.

### CROSS REFERENCE TO RELATED APPLICATIONS

This application claims priority to IT application Ser. No. 10/202,3000004347 filed on Mar. 8, 2023 which is incorporated herein by reference in its entirety.

### Field

The present invention refers to the technical field of electrical connectors. In particular, the present invention relates to lever-type connectors. Even more in particular, the present invention refers to a lever-type connector with a lever unit comprising an additional component.

### State of the Art

A lever-type connector is a connector including a lever with a cam mechanism, which enables connecting the lever-type connector with a mating connector in an easy way and by applying a small force.

Lever-type connectors are known at the state of the art. For example, document US 2020/0313351 A1 discloses a lever-type connector with a connector housing that includes a wire holding portion. A wire extends from the connector housing and has an end part held in the wire holding portion. A lever is assembled with the connector housing and is rotatable from a connection start position to a connection end position.

When an operator wants to remove the lever-type connector from the connection position with the mating connector, they have to rotate the lever from the connection position to a disengagement position. However, in some connection configurations where the lever-type connector is placed behind one or more barriers, it may be difficult to reach the lever and remove the lever-type connector.

It is therefore an object of the present invention to provide a lever-type connector that solves the above-stated problem.

### SUMMARY

According to the present invention, a lever-type connector is provided, which comprises a connector, a lever pivotally mounted on the connector and configured to secure a connection between the connector and a mating connector, and a gripping component configured to be gripped by an operator. The gripping component is pivotally mounted on an external part of the lever facing the operator, in such a way that a movement of the gripping component automatically induces a movement of the lever.

This solution is advantageous because it enables the operator to easily grip the gripping component even when the lever-type connector is placed in a position with no access from the front and/or from the sides. By pushing or pulling the gripping component, the operator can automatically push or pull the lever, thus assembling or disassembling the lever-type connector with the mating connector. The operator can hence control the lever by handling the gripping component.

The gripping component is advantageously designed in such a way to help the operator to grab it, even when the lever-type connector is placed behind one or more barriers. Preferably, the gripping component may have a U-shape, in order to enable handling by the operator. Preferably, the gripping component may comprise one or more gripping flaps for facilitating gripping.

According to a preferred configuration, the gripping component comprises a locking element for locking it to the lever, for instance the locking element may be a latch.

The locking element can be advantageously used to block the reciprocal position of the gripping component and the lever, for instance when the lever-type connector is assembled to the mating connector in a working configuration and there is no need to disassemble the two connectors.

According to a preferred configuration, the gripping component is pivotally mounted on the lever by means of a pair of press-fit pivots.

This configuration is advantageous because it enables rotation of the gripping component from a resting position, where the gripping component is in contact with the lever, to a lifting position, where the gripping component is lifted from the lever. When the gripping component is in the lifting position, the operator can hold it and can push or pull the gripping component and, accordingly, the lever.

### BRIEF DESCRIPTION OF THE DRAWINGS

The present invention will be described with reference to the attached figures in which the same reference numerals and/or signs indicate the same part and/or similar and/or corresponding parts of the machine.

FIG. 1 schematically illustrates a three-dimensional view of a lever-type connector according to an embodiment of the present invention.

FIG. 2 schematically illustrates a three-dimensional view of a lever-type connector according to the prior art, when positioned behind a barrier.

FIG. 2b schematically illustrates a three-dimensional view of a lever-type connector according to the prior art.

FIG. 3 schematically illustrates a three-dimensional view of a lever-type connector according to the present invention, wherein the gripping component is in the lifting position.

FIG. 4 schematically illustrates a detail of the gripping component according to an embodiment of the present invention.

FIG. 5 schematically illustrates a detail of the gripping component according to an embodiment of the present invention.

FIG. 6 schematically illustrates a detail of the connection between the gripping component and the lever, according to an embodiment of the present invention.

FIG. 7 is a cross-sectional view of the locking element of the gripping component for locking the gripping component and the lever, according to an embodiment of the present invention.

### DETAILED DESCRIPTION

In the following, the present invention is described with reference to particular embodiments as shown in the enclosed drawings. Nevertheless, the present invention is not limited to the particular embodiments described in the following detailed description and shown in the figures, but, instead, the embodiments described simply exemplify several aspects of the present invention, the scope of which is defined by the appended claims.

In the present disclosure, it is understood that expressions such as “top/up”, “down/low”, “front”, “clockwise/counter-clockwise” refer to the orientations and directions of the components shown in the figure, but they should not be deemed as limiting the scope of protection of the present invention.

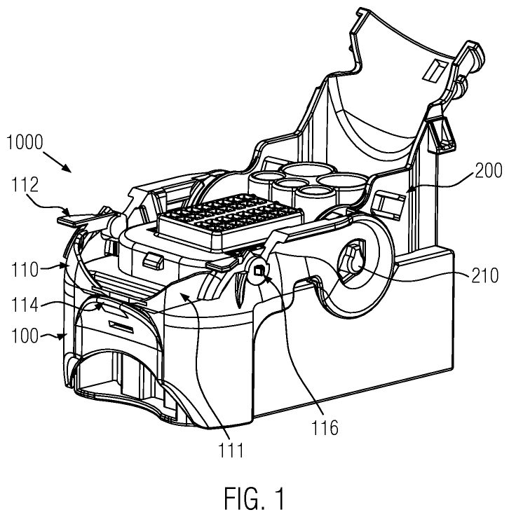

FIG. 1 schematically illustrates a lever-type connector 1000 according to an embodiment of the present invention.

The lever-type connector 1000 comprises a connector 200 and a lever 100. The connector 200 may be a male or a female electrical connector, which is configured to be connected to a mating connector (not shown). For instance, the mating connector may be an electronic control unit (ECU). Preferably, the lever-type connector according to the present invention may be used in the automotive field.

The lever 100 is pivotally mounted on the connector 200 by means of two pivots 210 and is configured to secure a connection between the connector 200 and the mating connector. In particular, the lever is rotatable from a connection start position or lifting position (not shown) to a connection end position or resting position, which is schematically shown in FIG. 1. In the connection end position, the lever 100 is in contact with the connector 200 and secures the electrical and mechanical connection with the mating connector.

A gripping component 110 is mounted on the lever 100 and is configured to be gripped by an operator during connecting and disconnecting operations. The gripping component 110 shown in FIG. 1 is substantially U-shaped and comprises a crossbar 111, which is connected to the lever 100 by means of two lateral arms with pivots 116. The gripping component 110 comprises two gripping flaps 112, which slightly protrude from the crossbar 111, in order to facilitate gripping by an operator in a condition wherein the lever-type connector 1000 is placed behind one or more barriers. The gripping component 110 further comprises a locking element 114 for locking the gripping component 110 to the lever 100 in the configuration wherein the connector 200 is electrically connected to the mating connector and there is no need to remove it.

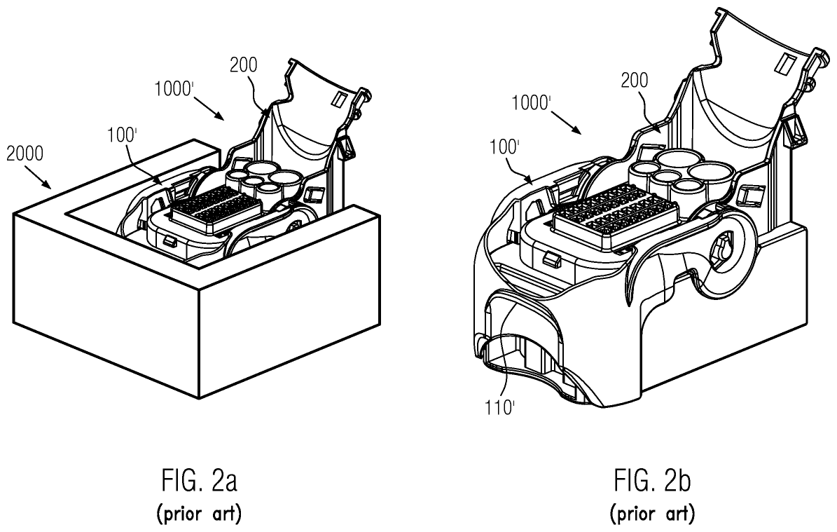

FIGS. 2a and 2b schematically illustrate a three-dimensional view of a lever type connector 1000′ according to the prior art.

The lever-type connector 1000′ according to the prior art comprises a connector 200 and a lever 100′. As shown in FIG. 2b, the lever 100′ comprises a recess 110′ in the front part, which is shaped to enable insertion of the fingers of an operator. In this way, when the connector 200 needs to be disassembled from the mating connector, the operator can insert the fingers inside the recess 110′ and can grip and lift the lever 100′.

As it is schematically shown in FIG. 2a, when the lever-type connector 1000′ according to the prior art is placed in a compartment comprising one or more barriers 2000, there is no access for the operator from the front side of the lever-type connector 1000′. Therefore, the operator cannot grip and lift the lever and cannot disassemble the connector 200 from the mating connector.

The lever-type connector 1000 according to the present invention, solves the problems of the prior art by providing the lever 100 with an additional component, i.e. the gripping component 110.

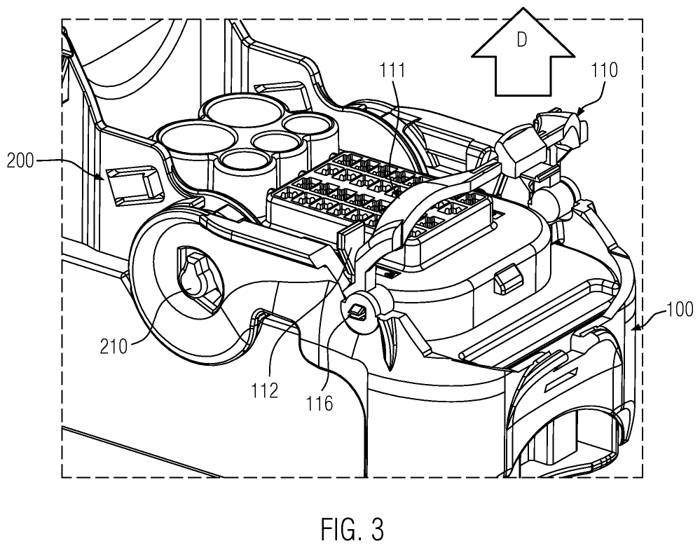

As it is schematically shown in FIGS. 1 and 3, the gripping component 110 is pivotally mounted on the lever 100 and it is designed in such a way that it can be easily reached and gripped by an operator, even when the lever-type connector 1000 is placed in a compartment comprising one or more barriers. The operator can hence pull the gripping component 110 and can accordingly pull the lever 100. In this way, the operator can easily assemble and disassemble the connector 200 and the mating connector by operating the lever 100 by means of the gripping component 110, regardless of the using conditions of the lever-type connector 1000.

FIG. 3 schematically illustrates a configuration wherein the gripping component 110 is in a lifting position. During use, the operator can grasp the gripping flaps 112 and lift the gripping component 110 along the direction D. Once the gripping component 110 is partially lifted, the operator can place his hand on the crossbar 111 and apply a force to pull the gripping component 110 along the direction D to reach the lifting position. When applying the force, the operator induces a counterclockwise rotation of the gripping component 110 around the axis defined by the pivots 116. By continuing pulling the gripping component 110, the operator automatically also induces a movement of the lever 100, which is rotated around the axis defined by the connector pivots 220. In this way, the lever 100 is also lifted.

A similar method may be used when pushing the lever in the resting position on the connector 200. In fact, the operator can handle the gripping component 110 by means of the crossbar 111 and consequently push both the gripping component 110 and the lever 100 in the direction opposite to the D direction indicated in FIG. 3. In this way, the operator can induce a rotation of the lever 100 around the axis defined by the pivots 210 from an upper position wherein the lever 100 is not in contact with the connector 200, to a lower position, wherein the lever 100 is in contact with the connector 200. The lower position corresponds to a connection end position, wherein the connector 200 is securely assembled with the mating connector.

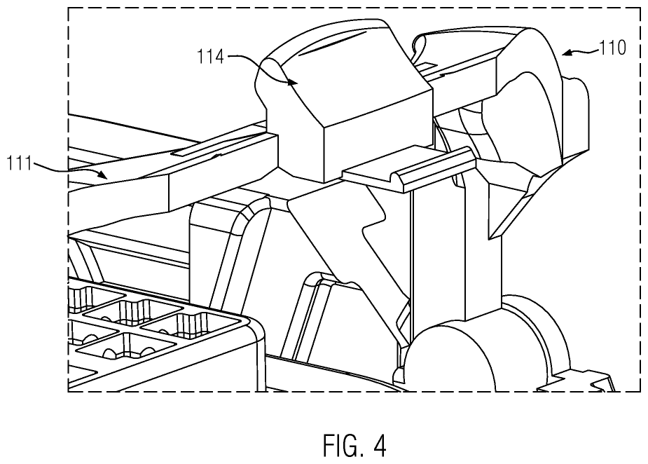

FIG. 4 schematically illustrates a detail of the crossbar 111 of the gripping component 110, which comprises a locking element 114. Preferably, the locking element 114 is a latch, which is a simple and efficient system of locking two components together. The latch 114 is snap-fit into a corresponding recess of the lever 100, to lock the two components together. The gripping component 110 and the lever 100 must be locked together when the connector 200 and the mating connector are electrically connected and there is no need to dissemble them. In this way, the electrical connection is not damaged by mechanical stress or mechanical vibrations, which typically occur in automotive applications.

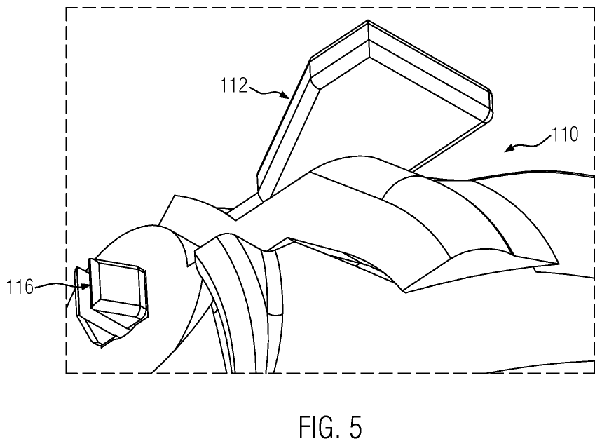

FIG. 5 schematically illustrates a detail of the gripping component 110 comprising two gripping flaps 112. As described above, each gripping flap 112 slightly protrudes from the crossbar 111 of the gripping component 110. In particular, each gripping flap 112 extends towards the outside of the gripping component 110 so that it can be easily grasped by the operator. The operator can insert one or more fingers in the gap formed between the gripping flap 112 and the crossbar 111 and can then apply a force to lift and pull the entire gripping component by means of the gripping flaps 112. Preferably, two gripping flaps 112 are formed on the gripping component 110 and they are placed on opposite sides of the crossbar 111, close to the corresponding pivots 116.

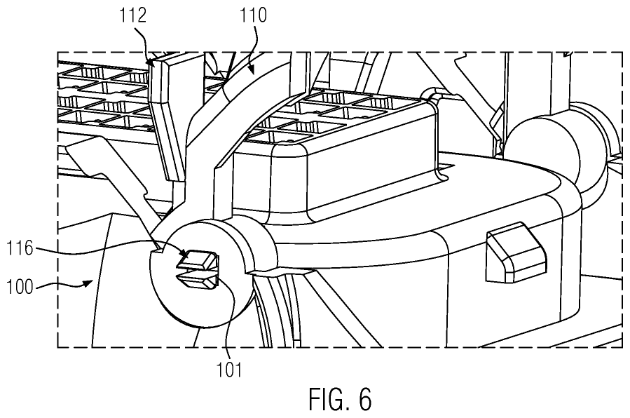

FIG. 6 schematically illustrates a detail of the connection mechanism between the gripping component 110 and the lever 100. Preferably, the gripping component 110 has a U-shape and the lateral arms of the U are connected to the lever 100 by means of corresponding pivots 116. Pivots are advantageous because they enable rotation on the lever from an upper position to a lower position in contact with the connector 200. The pivots 116 are advantageously press-fit into corresponding holes 101 formed on the wall of the lever 100. In this way, the gripping component 110 and the lever 100 can be mounted together in an easy and secure way. Each pivot 116 comprises two elastic parts, which are forced to fit into a corresponding hole 101 of the lever. After insertion, the two elastic parts can slightly separate from each other, so as to secure the connection between the gripping component 110 and the lever 100.

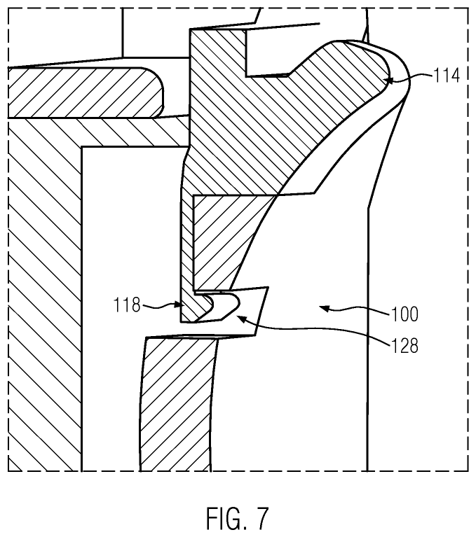

FIG. 7 schematically illustrates a sectional view of the connection between the gripping component 110 and the lever 100, wherein the latch 114 of the gripping component 110 is inserted into the corresponding recess 128 for in the lever 100. The latch 114 enables securely locking the gripping component 110 to the lever 100, in order to provide mechanical stability to the lever-type connector 1000.

Preferably, the lever-type connector according to the present invention is made of a thermo-plastic material, such as nylon or PVT, or any other non-conductive material. Preferably, the thermal plastic material is the same material of the connector 200.

Further modifications and variations of the present invention will be clear for the person skilled in the art. Therefore, the present description has to be considered as including all the modifications and/or variations of the present invention, the scope of which is defined by the appended claims.

For simplicity, identical or corresponding components are indicated in the figures with the same reference numbers.

### Reference Numbers

100: lever
100′: lever according to prior art
101: hole
110: gripping component
111: crossbar
112: gripping flap
114: locking element
116: press-fit pivot
118: protruding part
200: connector
210: connector pivot
1000: lever-type connector
1000′: lever-type connector according to prior art
2000: compartment walls

1. A lever-type connector comprising:
a connector;
a lever pivotally mounted on said connector and configured to secure a connection between said connector and a mating connector;
said lever-type connector further comprises a gripping component configured to be gripped by an operator, wherein said gripping component is pivotally mounted on an external part of said lever facing said operator, in such a way that a movement of said gripping component automatically induces a movement of said lever.

2. The lever-type connector of claim 1, wherein said gripping component has a U-shape.

3. The lever-type connector of claim 1, wherein said gripping component comprises one or more gripping flaps.

4. The lever-type connector of claim 1, wherein said gripping component comprises a locking element for locking said gripping component to said lever.

5. The lever-type connector of claim 4, wherein said locking element comprises a latch.

6. The lever-type connector of claim 1, wherein said gripping component is pivotally mounted on said lever by means of a pair of press-fit pivots.

7. The lever-type connector of claim 1, wherein said lever-type connector is made of a thermo-plastic material, for example nylon or PBT.

8. A lever-type connector assembly comprising:
a lever-type connector according to claim 1;
a mating connector.

9. The lever-type connector of claim 8, wherein said mating connector is an Electronic Control Unit (ECU).

10. Method for operating the lever-type connector according to claim 1, said method comprising the following steps:
gripping said gripping component while said connector is blocked in a connection position with a mating connector by means of said lever;
pulling said gripping component, whereby said lever is automatically pulled so as to unblock said connector.

11. Method for operating the lever-type connector according to claim 1, said method comprising the following steps:
gripping said gripping component while said connector is connected to a mating connector in an intermediate connection position;
pushing said gripping component, whereby said lever is automatically pushed so as to block said connector in a connection position with said mating connector.
